(19) United States
(12) Patent Application Publication
(10) Pub. No.: US 2014/0132693 A1
(43) Pub. Date: May 15, 2014

(54) Method and System for Marking a Fish Tape Using a Laser Marking System

(71) Applicant: KLEIN TOOLS, INC., Lincolnshire, IL (US)

(72) Inventor: John H. Kargenian, Buffalo Grove, IL (US)

(73) Assignee: KLEIN TOOLS, INC., Lincolnshire, IL (US)

(21) Appl. No.: 13/675,005

(22) Filed: Nov. 13, 2012

(51) Int. Cl. B41M 5/00

(52) U.S. Cl. CPC B41M 5/0041
USPC 347/110

(57) ABSTRACT

A laser marking system for marking indicia onto fish tape that directs a laser beam towards a first print track and a second print track positioned within a laser marking zone, a first source of fish tape material and a second source of fish tape material, first and second fish tape guides for guiding the first and second fish tape materials onto the first and second print tracks, wherein the movement of the first and second fish tape materials over the first and second print tracks may be performed independently of each other, and first and second laser indicia may be marked on the first and second fish tapes.

### FIELD

This patent application is directed to systems and methods for laser marking elongate materials with indicia. In particular, this patent application is directed to systems and methods for the marking of indicia on one or more fish tapes using a laser.

### BACKGROUND

During construction and/or renovation projects, electricians and other workers at times are required to pull electrical power, phone, or data cable/wires/lines etc. (“cable” or “electrical wiring”) and/or to measure the length of cable retaining structures, such as conduit, channels, ducts, or passageways (“conduit”) located in walls, floors, and ceilings. In the course of installing cable or electrical wiring through a conduit, an electrician will commonly use a tool known as a fish tape. A fish tape may be used by electricians to pull electrical wiring through conduit positioned within a wall, floor, or ceiling. Typically, a fish tape is an elongated member that may be made of tempered spring steel, stainless steel, nylon, fiberglass core with a nylon jacket, a nylon core with a fiberglass jacket, or a multi-stranded wire. A fish tape is also quite narrow, and is typically found in thicknesses of ⅛ inch, 3/16 inch, or ¼inch.

The fish tape may have a rectangular or square cross section, or a circular or oval cross section. A fish tape is required to be rigid enough to be pushed through a run of conduit, yet flexible enough to bend around corners or curves that may be inherent in a particular run of conduit. As an example, a fish tape may need to bend and turn through 90 degree angles within a run of conduit, for example when running cable from a wall outlet to a ceiling fan. A fish tape may be required to pull cable through conduit having a significant length. Thus, a fish tape may be provided in lengths of 25 feet, 50 feet, 100 feet, 120 feet, 125 feet, and even up to 240 feet or more. Given its sometimes long length, to make the storage of the fish tape possible, a fish tape is typically wound or coiled on a reel or spool which may be enclosed by a housing.

One end of the fish tape, the proximal end, is usually anchored to a stationary or rotatable portion of a reel or spool to keep the end from coming loose. The other end, leading (or distal) end, of the fish tape is adapted in some way (e.g., hooked) to readily attach the leading end of the fish tape to the cable or electrical wiring to be pulled by the fish tape through the conduit.

In use, after the fish tape has been “fished” or inserted through the conduit, the cable or electrical wiring to be installed is affixed to the leading end of the fish tape and the fish tape is pulled back through the conduit to draw the cable or electrical wiring along with the fish tape. Once through, the cable or electrical wiring is typically terminated at any necessary connection on each end and installation of cable or electrical wiring within the conduit is complete.

When installing cable or electrical wiring, it is desirable to measure a length of a particular run of conduit and/or a location of an obstruction in the conduit in which the cable or electrical wiring is to be installed. An inaccurate measurement or estimate may cause the installer to cut the cable or electrical wire too short, or too long, resulting in wasted scrap cable or electrical wiring and therefore wasted money.

One way to measure the length of the run is to use measuring string. When using measuring string, the fish tape is first inserted at the proximal end of the run and fished to the distal end of the run. Next, a measuring string (and perhaps an accompanying pull string) is affixed to the leading end of the fish tape appearing at the distal end of the run. Then, the fish tape and the attached string(s) are pulled back through the conduit. When the leading end of the fish tape has been retrieved from the proximal end of the run, the installer can determine the length of the run via the measuring the length of the string. The cable or electrical wiring to be used may then be cut (although not necessarily) to the appropriate length. To install the cable or electrical wiring in the conduit, the cable or electrical wiring is then affixed to the leading end of the measuring string(s) appearing at the proximal end of the run and are pulled back through the conduit. Once through, cable or electrical wiring may be terminated as necessary.

Another way to measure the run is to first insert the fish tape at the proximal end of the run and to fish the fish tape to the distal end of the run. Once the leading end of the fish tape appears at the distal end of the run, the installer manually marks (perhaps with a piece of tape or a pen, etc.) the section of fish tape that is nearest to the proximal end of the run, pulls out the fish tape, and lays the fish tape on the ground. The distance between the leading end of the tape and the marked section on the tape represents the length of the conduit run and thus the required length of cable or electrical wiring required. The cable or electrical wiring is then measured against the fish tape and may be cut to the appropriate lengths. In a next step, the fish tape is reinserted at the proximal end of the run and fished to the distal end of the run. Finally, to install the cable or electrical wiring in the conduit, the cable or electrical wiring is then affixed to the leading end of the fish tape appearing at the distal end of the run and are pulled back through the conduit.

Some prior art fish tapes have markings much like a common measuring tape. In particular, they start with a “zero” indication at or near the leading end (distal end) of the fish tape and end with the highest unit measurement (i.e., “100” for a 100 foot fish tape) on the innermost usable part of the fish tape (proximal end), i.e., the part affixed to the stationary or rotatable part of the reel or spool. Under certain conditions, these markings allow the electrician to determine the length of cable required for a particular application prior to the pull. However, in some instances electricians cut off the end of the fish tape that the cable or electrical wiring has been tied to. As a result, because the end of the fish tape may be “consumed” by an electrician cutting off the end of the fish tape, the conventional numbering system of the type found on a tape measure will no longer provide an accurate measurement of the length of a run of conduit because the leading end of the fish tape no longer starts at “0” once the end has been cut off, or consumed. In addition, in such instances often an electrician would not know the length of fish tape remaining on the spool or reel without knowing how much of the fish tape had been cut off or consumed.

One solution to this problem was to provide a reverse marked fish tape having numerals increasing from a fixed end of the fish tape to the leading end of the fish tape. Because the numbers are reversed from the numbering found on a conventional fish tape, even when the leading end of the fish tape is cut off or consumed, the length of fish tape remaining may be ascertained simply by looking at the marking at the leading end of the fish tape. For more information on reverse markings and different markings that may be applied to fish tapes, the reader is referred to U.S. patent application Ser. No. 12/334,637, entitled “Reverse Marked Fish Tape,” the entire contents of which are fully incorporated herein by reference as if fully set forth herein.

Fish tapes may be marked with English units, such as inches and feet. For example, a fish tape may include marking in the form of numeric indicia positioned at each foot along the length of the fish tape. In some instances, it may be desirable to include indicia indicative of even smaller increments, for example every six inches, or even every inch. Similarly, fish tape may be marked with metric units, such as centimeters and meters. Thus, a fish tape may include marking in the form of numeric indicia positioned at each meter along the length of the fish tape. In some instances, it may be desirable to include indicia indicative of even smaller increments, for example every half meter, or even every centimeter.

Furthermore, as noted above, fish tapes may come in variously sized cross sections such as rectangular, square, oval, or round as examples. They may also come in various sizes. For example, a fish tape may be ⅛ inch, 3/16 inch, or ¼inch wide in the case of a rectangular or square cross section or may have a diameter of ⅛ inch 3/16 inch, or ¼inch in the case of a round cross section. Fish tapes may also comprise different materials such as steel, or nylon core with a fiberglass glass jacket, or a fiberglass core with a nylon jacket. Fish tapes may also come in various lengths as noted above.

As a result of the wide variety of lengths, cross sections, sizes, and varying indicia of fish tapes that may be desired or required in a fish tape, there is a need to provide a system and method for marking fish tapes of various lengths, cross sections, and sizes, with varying indicia that is efficient and economical.

### SUMMARY

The present embodiments disclose a laser marking system for marking indicia onto fish tape material that includes a laser marking module with a laser system for directing a laser beam towards a first print track and a second print track positioned within a laser marking zone, a first source of fish tape material, a first fish tape guide for guiding the first fish tape material onto the first print track, a first controller for controlling the movement of the first fish tape over the first print track, a second source of fish tape material, a second fish tape guide for guiding the second fish tape material onto the second print track, a second controller for controlling the movement of the second fish tape over the second print track, wherein movement of the first fish tape material may be performed independently from the movement of the second fish tape material, and wherein first laser indicia may be marked on the first fish tape material positioned on the first print track in the laser marking zone by the laser beam and second laser indicia may be marked on the second fish tape material positioned on the second print track in the laser marking zone by the laser beam.

Embodiments of the laser marking system may further include a take up module having a first take up bobbin for winding up the first fish tape material after it passes through the laser marking zone and a second take up bobbin for winding up the second fish tape material after it passes through the laser marking zone.

Additional embodiments of the laser marking system may also further include a third print track positioned within the laser marking zone, a third source of fish tape material, a third fish tape guide for guiding the third fish tape material onto the third print track, a third controller for controlling the movement of the third fish tape over the third print track, wherein movement of the third fish tape material may be performed independently from the movement of the first fish tape material and the second fish tape material, and wherein third laser indicia may be marked on the third fish tape material positioned on the third print track in the laser marking zone by the laser beam. The laser marking system may also further include a third take up bobbin on the take up module for winding up the third fish tape material after it passes through the laser marking zone.

Additional embodiments of the laser marking system may also further include a fourth print track positioned within the laser marking zone, a fourth source of fish tape material, a fourth fish tape guide for guiding the fourth fish tape material onto the fourth print track, a fourth controller for controlling the movement of the third fish tape over the third print track, wherein movement of the fourth fish tape material may be performed independently from the movement of the first fish tape material, the second fish tape material, and the third fish tape material, and wherein fourth laser indicia may be marked on the fourth fish tape material positioned on the fourth print track in the laser marking zone by the laser beam. The laser marking system may also further include a fourth take up bobbin on the take up module for winding up the fourth fish tape material after it passes through the laser marking zone.

Example embodiments also include a method of laser marking one or more fish tapes with indicia comprising the steps of moving a first fish tape material from a first source of fish tape material through a first fish tape guide onto a first print track positioned in a laser marking zone of a laser marking module that includes a laser system, directing a laser beam towards the first fish tape material positioned in the first print track to laser mark the first fish tape material with first laser indicia, and a second print track positioned within a laser marking zone, moving a second fish tape material from a second source of fish tape material through a second fish tape guide onto a second print track positioned in the laser marking zone of the laser marking module, directing a laser beam towards the second fish tape material positioned in the second print track to laser mark the second fish tape material with second laser indicia, wherein movement of the first fish tape material is performed independently from the movement of the second fish tape material.

The method of laser marking may further include the step of moving a third fish tape material from a third source of fish tape material through a third fish tape guide onto a third print track positioned in the laser marking zone of the laser marking module, directing a laser beam towards the third fish tape material positioned in the third print track to laser mark the third fish tape material with third laser indicia, wherein movement of the third fish tape material is performed independently from the movement of the first fish tape material and the second fish tape material.

The method of laser marking may also further include the step of moving a fourth fish tape material from a fourth source of fish tape material through a fourth fish tape guide onto a fourth print track positioned in the laser marking zone of the laser marking module, directing a laser beam towards the fourth fish tape material positioned in the fourth print track to laser mark the fourth fish tape material with fourth laser indicia, wherein movement of the fourth fish tape material is performed independently from the movement of the first fish tape material, the second fish tape material, and the third fish tape material.

### BRIEF DESCRIPTION OF THE DRAWINGS

Exemplary embodiments are described herein with reference to the drawings, wherein like parts are designated by like reference numerals, and wherein:

FIG. 1 is a block diagram of a laser marking system;

FIG. 2 is a perspective view of a laser marking system, including a fish tape supply bobbin assembly supplying fish tape material to the laser marking system and take up bobbin assembly for storing the fish tape material once it has been laser marked;

FIG. 3 is a front view of the laser marking system and assemblies shown in FIG. 2;

FIG. 4 is rear view of the laser marking system and assemblies shown in FIGS. 2 and 3;

FIG. 5 is right side view of the laser marking system and assemblies shown in FIGS. 2-4;

FIG. 6 is a left side view of the laser marking system and assemblies shown in FIGS. 2-5;

FIG. 7 is a top view of the laser marking system and assemblies shown in FIGS. 2-6; and

FIG. 8 is an alternate embodiment of a laser marking system and assemblies.

### DETAILED DESCRIPTION

In the following detailed description, reference is made to the accompanying Figures where similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a variety of different configurations, all of which are explicitly contemplated herein.

The present application is directed to a method and system for marking indicia, such as numerical indicia, on a fish tape using a laser. The laser marking system includes a laser device for emitting a marking beam, and means for moving a length of fish tape material through a marking zone relative to the laser device. The laser marking system also includes means for stopping the movement of the length of fish tape at a desired distance to allow for the laser to mark the indicia onto the fish tape while the fish tape is in a stationary position. The method and system also determines the length of fish tape material that has moved through the marking zone, so that it may control the periodic stopping, and starting, of the movement of the fish tape to allow for the desired indicia to be marked on the fish tape by the laser in the laser marking zone. The fish tape material itself may include an additive that changes color when exposed to the laser, so that the indicia marked on the fish tape by the laser are more permanent than other types of laser marked indicia.

In addition, the laser marking system has a plurality of fish tape print tracks that may accommodate a plurality of fish tapes that are moved through the laser marking zone at the same time. Each of the fish tape print tracks may operate independently from each of the other fish tape print tracks. In this manner, the laser marking system provides for a plurality of fish tape print tracks that may allow for each print track to accommodate a fish tape having differing lengths, cross sections, sizes, and varying indicia to be placed thereon, as the varying fish tapes travel through the laser marking zone and are marked by the laser. The laser marking of the fish tape material in one print track may operate independently of the laser marking of a fish tape material in another print track. For example, a first print track may have fish tape material with a round 3/16 inch cross section that is laser marked with English numeric indicia for a 50 foot length, and a separate second print track may have fish tape material with a round 3/16 inch cross section laser marked with metric indicia for a 75 meter length at the same time. Similarly, the first print track could continue to operate and laser mark fish tape material while a second print track was changing over to a different type of fish tape material or undergoing maintenance, as examples.

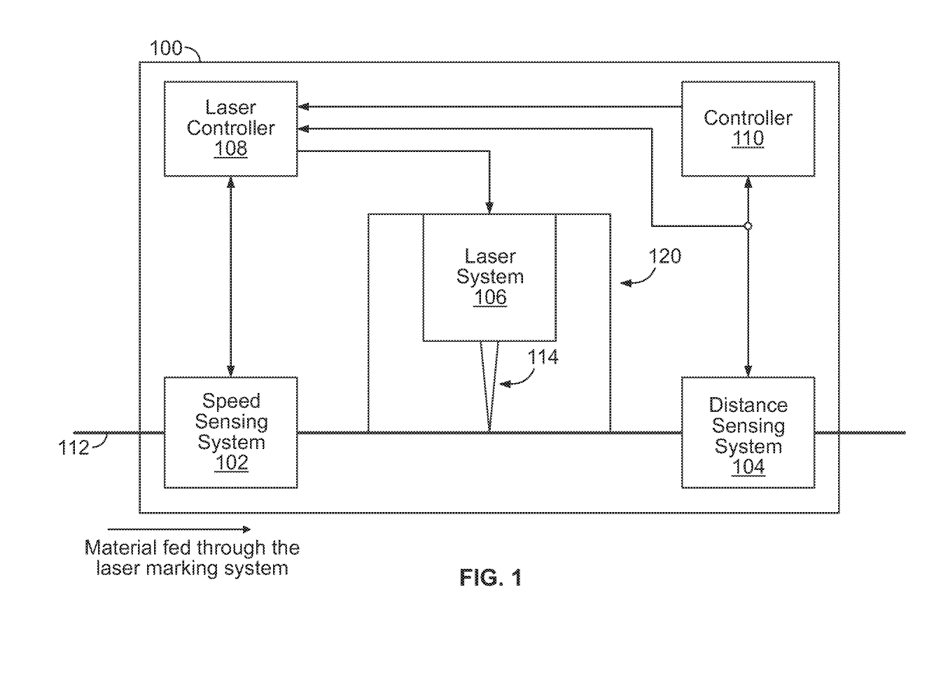

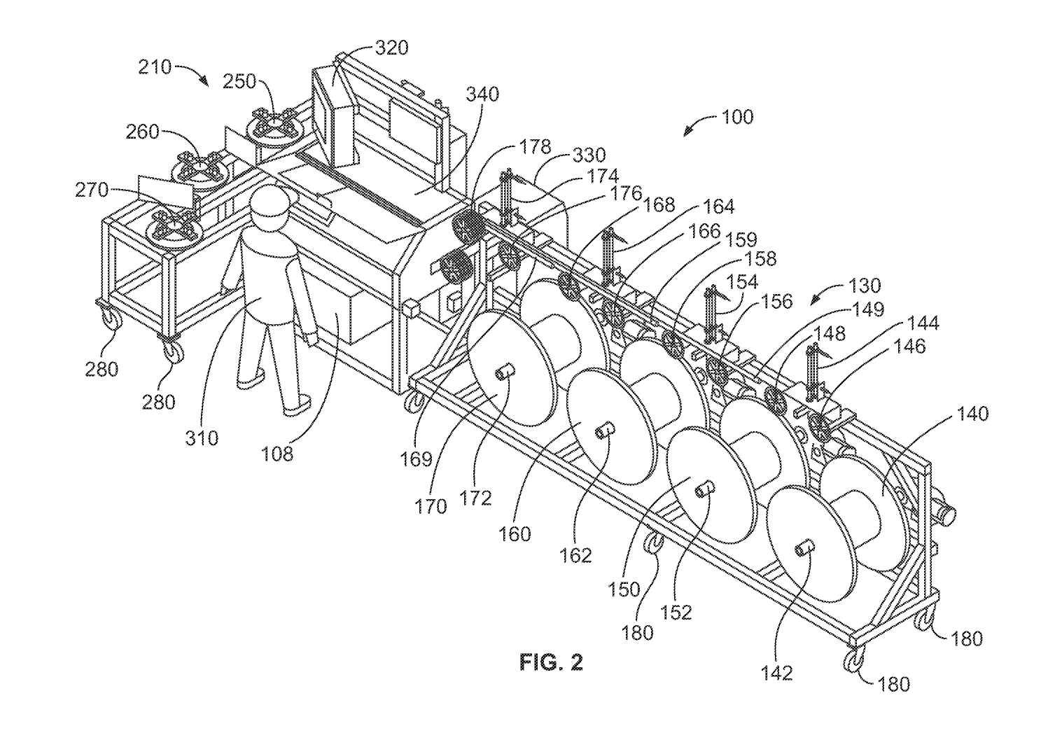

Referring now to the Figures, FIG. 1 shows a block diagram of an example laser marking system 100 that could be used in the disclosed embodiments of a laser marking system shown in FIGS. 2-8. The laser marking system 100 may include a speed sensing system 102, and/or a distance sensing system 104, a laser system 106, a laser controller 108, and a controller 110. A length of fish tape material 112 may be fed or drawn through the laser marking system 100 so that the fish tape material 112 passes into the laser marking zone 120 and comes to a stop positioned beneath the laser system 106. The laser system 106 directs a laser beam onto a portion of the fish tape material 112 to form indicia on the fish tape material 112. Once the laser is finished providing laser marked indicia on the fish tape material 112, the fish tape material 112 is moved a predetermined distance through the laser marking zone 120 until the next section of the fish tape material that is to receive laser marked indicia comes to a stop positioned beneath the laser system 106. The movement of the fish tape material 112 through the laser marking zone 120 is repeated as each successive portion of the fish tape material 112 comes to a stop positioned beneath the laser system 106. Once all of the indicia have been marked on the fish tape material 112, the resulting fish tape having laser marked indicia thereon may be cut as it exits the laser marking zone 120 for later processing, may be wound onto a take up bobbin and cut to length for later attachment and insertion into a fish tape housing, or may be wound onto a take up bobbin, uncut for later processing.

The laser marking system 100 may include a speed sensing system 102 that may monitor how fast the fish tape material 112 is fed or drawn through the laser marking system 100, and thus how much length of fish tape material 112 has passed into the laser marking zone 120. The laser marking could alternately include a distance sensing system 104 that may monitor how much fish tape material 112 has passed into the laser marking zone 120. Or the laser marking system could use a combination of a speed sensing system 102 and a distance sensing system 104 to determine how much fish tape material 112 has passed into the laser marking zone. In this manner, the speed sensing system 102 and/or distance sensing system 104, in conjunction with controller 110, may control the distance that the fish tape material 112 moves into the laser marking zone 120 in order to properly position the fish tape material 112 to have a predetermined set of indicia marked onto the fish tape material 120 at the appropriate predetermined intervals.

The laser controller 108 may receive a signal from the speed sensing system 102 indicating a speed the fish tape material 112 is passing through the laser marking zone 120, and/or a signal from the distance sensing system 104 indicating how much fish tape material 112 has passed through the laser marking zone 120, as well as instructions from the controller 110 indicating when to mark the fish tape material 112.

The laser controller 108 may output a signal to the laser 106 directing the laser 106 how to laser mark the fish tape material 112. The controller 110 may be programmed to control operation of the laser controller 108. For example, the controller 110 may receive a signal from the distance sensing system 104 indicating that a length of one foot has passed through the marking zone, and the controller 110 may then instruct that the movement of the length of fish tape material through the laser marking zone is stopped, and instruct that the laser marking of the next predetermined indicia is performed. The controller 110 may also receive a signal from the distance sensing system 104 indicating that 50 feet of material have passed through the system, and the controller 110 may then instruct the laser controller 108 to end a marking phase. The controller 110 may also send signals to the distance sensing system 104 indicating to reset to a home position for a new marking cycle, and/or indicating to reset to an offset position for a new marking cycle, for example.

The controller 110 can control application of the laser beam 114 to the fish tape material 112 to produce the desired set of marks on the fish tape material 112 by sending instructions to the laser controller 108. The controller 110 may be preprogrammed according to a desired marking pattern or list files for each possible length, cross section, size of fish tape material to be used, as well as each set of indicia that may be desired to laser mark onto the fish tape material 112. The laser marking system may include a user interface (not shown) to allow an operator to input controls to the laser marking system 100, for example.

The controller 110 may also be connected to a motor (not shown) and may provide instructions to the motor indicating how fast or how far the fish tape material 112 should be fed or drawn through the laser marking zone 120 to produce a desired set of indicia laser marked on the fish tape material 112. The controller 110 may be a programmable logic controller, a field programmable logic array (FPLA), or a computer that can receive signals, and provide corresponding instructions to other components of the system 100, for example.

In FIG. 1, the speed sensing system 102 and the distance sensing system 104 are illustrated as separate components. However, the speed sensing system 102 and the distance sensing system 104 could be used alternatively, may be used in combination, or may be combined into one component or one sensor to output both a speed signal indicating a speed of the fish tape material 112 through the system laser marking zone 120, and/or a distance signal a distance the fish tape material 112 that has passed through the laser marking zone 120.

Furthermore, in other configurations, the laser controller 108 and the controller 110 may be combined into one element that controls operation of the laser marking system 100. Other configurations are possible as well.

The present embodiments contemplate up to four or more different print tracks passing through the laser marking zone 120 allowing for four different fish tapes to be marked at the same time. The laser marking of the four different fish tapes may be controlled by laser control 108 and/or controller 110, or each print track could have its own dedicated controller(s). The laser system 106 may also comprise one or more lasers to allow for the four separate fish tapes to be laser marked in the laser marking zone 120.

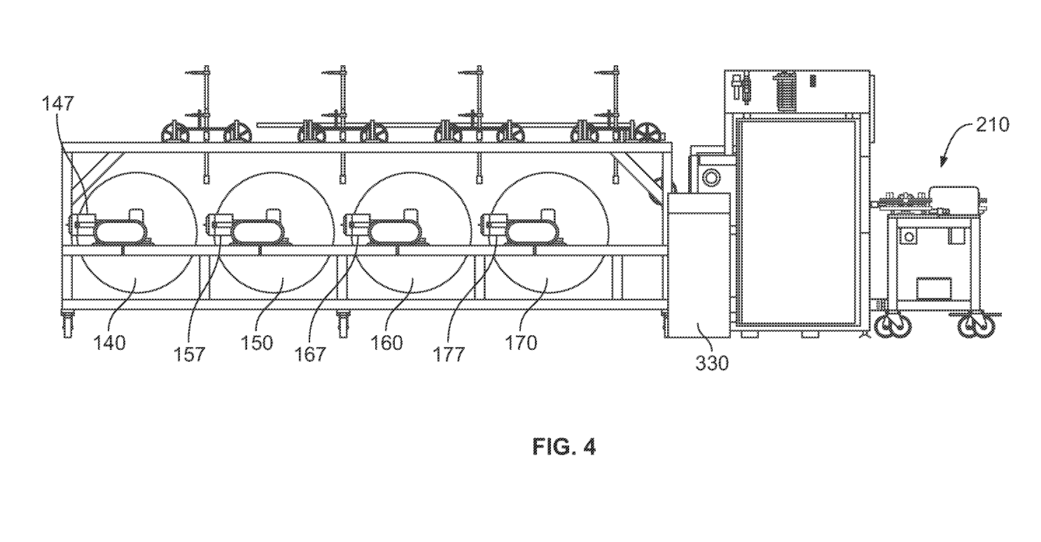

FIG. 2 illustrates a perspective view of a laser marking system 100. The laser marking system 100 is shown having a supply module 130, a print module 340, and a take-up or collection module 210. The supply module 130 includes a first bobbin 140 that is positioned over a first bobbin shaft 142. While a first bobbin is shown, the source of fish tape material need not be positioned on a bobbin. The first bobbin 140 is wound with fish tape material (not shown) to be fed or drawn through the print module 340. The fish tape material wound on the first bobbin 140 will be unwound from the first bobbin 140 and drawn or fed onto a first print track within the print module 340. The fish tape material is unwound from the first bobbin 140 and positioned over pulleys 146 and 148 and into first control conduit 149. The fish tape material from the first bobbin 140 passes through first control conduit 149, over additional pulleys, and into the print module 340 where indicia are laser marked onto the fish tape. Preferably the fish tape passes from pulleys 146 and 148 directly into the first control conduit 149, although the fish tape may also pass from the pulleys 146 and 148 into first control conduit 149 at an angle. A sensor 144 is positioned adjacent pulleys 146 and 148 and may sense the speed and/or distance the fish tape has traveled over the pulleys 146 and 148. Sensor 144 is designed to assess the slack in the system. If there is too much or too little slack in the fish tape material as it leaves the bobbin, the sensor may send a signal to motor 147 (see FIG. 4) to provide the desired amount of slack.

The supply module 130 also includes a second bobbin 150 that is positioned over a second bobbin shaft 152. The second bobbin 150 is wound with fish tape material (not shown) to be fed or drawn through the print module 340. The fish tape material wound on the second bobbin 150 will be unwound from the second bobbin 150 and drawn or fed onto a second print track within the print module 340. The fish tape material is unwound from the second bobbin 150 and positioned over pulleys 156 and 158 and into second control conduit 159. The fish tape material from the second bobbin 150 passes through second control conduit 159, over additional pulleys, and into the print module 340 where indicia are laser marked onto the fish tape. Preferably the fish tape passes from pulleys 156 and 158 directly into the second control conduit 159, although the fish tape may also pass from the pulleys 156 and 158 into second control conduit 159 at an angle. A sensor 154 is positioned adjacent pulleys 156 and 158 and may sense the speed and/or distance the fish tape has traveled over the pulleys 156 and 158. Sensor 154 is designed to assess the slack in the system. If there is too much or too little slack in the fish tape material as it leaves the bobbin, the sensor may send a signal to motor 157 (see FIG. 4) to provide the desired amount of slack.

The supply module 130 includes a third bobbin 160 that is positioned over a third bobbin shaft 162. The third bobbin 160 is wound with fish tape material (not shown) to be fed or drawn through the print module 340. The fish tape material wound on the third bobbin 160 will be unwound from the third bobbin 160 and drawn or fed onto a third print track within the print module 340. The fish tape material is unwound from the third bobbin 160 and positioned over pulleys 166 and 168 and into third control conduit 169. The fish tape material from the third bobbin 160 passes through third control conduit 169, over additional pulleys, and into the print module 340 where indicia are laser marked onto the fish tape. Preferably the fish tape passes from pulleys 166 and 168 directly into the third control conduit 169, although the fish tape may also pass from the pulleys 166 and 168 into third control conduit 169 at an angle. A sensor 164 is positioned adjacent pulleys 166 and 168 and may sense the speed and/or distance the fish tape has traveled over the pulleys 166 and 168. Sensor 164 is designed to assess the slack in the system. If there is too much or too little slack in the fish tape material as it leaves the bobbin, the sensor may send a signal to motor 167 (see FIG. 4) to provide the desired amount of slack.

The supply module 130 includes a fourth bobbin 170 that is positioned over a fourth bobbin shaft 172. The fourth bobbin 170 is wound with fish tape material (not shown) to be fed or drawn through the print module 340. The fish tape material wound on the third bobbin 170 will be unwound from the third bobbin 170 and drawn or fed onto a fourth print track within the print module 340. The fish tape material is unwound from the fourth bobbin 170 and positioned over pulleys 176 and 178 and directed over an additional pulley and fed or drawn into the print module 340 where indicia are laser marked onto the fish tape. A sensor 174 is positioned adjacent pulleys 176 and 178 and may sense the speed and/or distance the fish tape has traveled over the pulleys 176 and 178. Sensor 174 is designed to assess the slack in the system. If there is too much or too little slack in the fish tape material as it leaves the bobbin, the sensor may send a signal to motor 177 (see FIG. 4) to provide the desired amount of slack.

The bobbins 140, 150, 160, and 170 may have a diameter of up to three feet or more to house wound fish tape material thereon. The fish tape material is preferably made of a fiberglass core with a nylon jacket. The cross-section is preferably round with a diameter of 3/16 inch. Using this type of fiberglass-cored fish tape material, up to 18,000-20,000 feet of fish tape material may be wound onto each of the bobbins 140, 150, 160, and 170. Of course, each of the bobbins could also have different or smaller size diameters and house fish tape materials having different sizes and cross sections, and comprised of different materials. Furthermore, as noted above, the source of the fish tape material need not be positioned on bobbins, and the material could be positioned in coils or stored on devices other than a bobbin.

The supply module 130 is shown with casters 180 that allow the supply module to be moved into proper alignment with the print module 340. The supply module 130 may have a quick disconnect attachment for the mechanical and electrical connections between the supply module 130 and the print module to allow for quick exchanges and maneuverability of the modular components. Each of the bobbins 140, 150, 160, and 170 may be removed from its respective bobbin shaft 142, 152, 162, and 172 to allow for a new bobbin to placed thereon when the fish tape material on the old bobbin runs low or runs out, or when it is desired to have a bobbin wound with fish tape material with a different size, shape, or material. Each of the bobbin assemblies for bobbins 140, 150, 160, and 170 could be modular and separately removable from the supply module 130 if desired for even increased modularity, versatility, and maneuverability.

Operator 310 is shown positioned in front of the print module 340, with a monitor that allows the operator to view the operational status and other parameters. A filtration unit 330 is shown positioned on a side opposite of the operator that serves to filter any smoke or debris from the laser marking process.

In some applications, the fish tape material, after it has been laser marked in the print module 340, may pass out of the print module 340 and be cut into appropriate lengths and set aside for later attachment and winding onto a fish tape housing in a secondary operation. However, in a preferred embodiment a take up module 210 is positioned adjacent the print module 340. The take up module 210 is optionally positioned adjacent the print module 340. As the fish tape material from the fourth bobbin 170 passes through the print module 340 and is laser marked with desired indicia it may be directly wound onto fourth take up bobbin or mandrel 270. Similarly, as fish tape material from the third bobbin 160 passes through the print module 340 and is laser marked with desired indicia it may be directly wound onto third take up bobbin or mandrel 260. In the same manner, as the fish tape material from the second bobbin 150 passes through the print module 340 and is laser marked with desired indicia it may be directly wound onto second take up bobbin or mandrel 250. In the same manner, as the fish tape material from the first bobbin 140 passes through the print module 340 and is laser marked with desired indicia it may be directly wound onto a first take up bobbin or mandrel 240 (not shown) located out of view behind panel 320 in FIG. 2. The take up module 210 is shown with casters 280 to easily move the take up module into and out of position as desired. Quick disconnects for mechanical and electrical connections may also be provided.

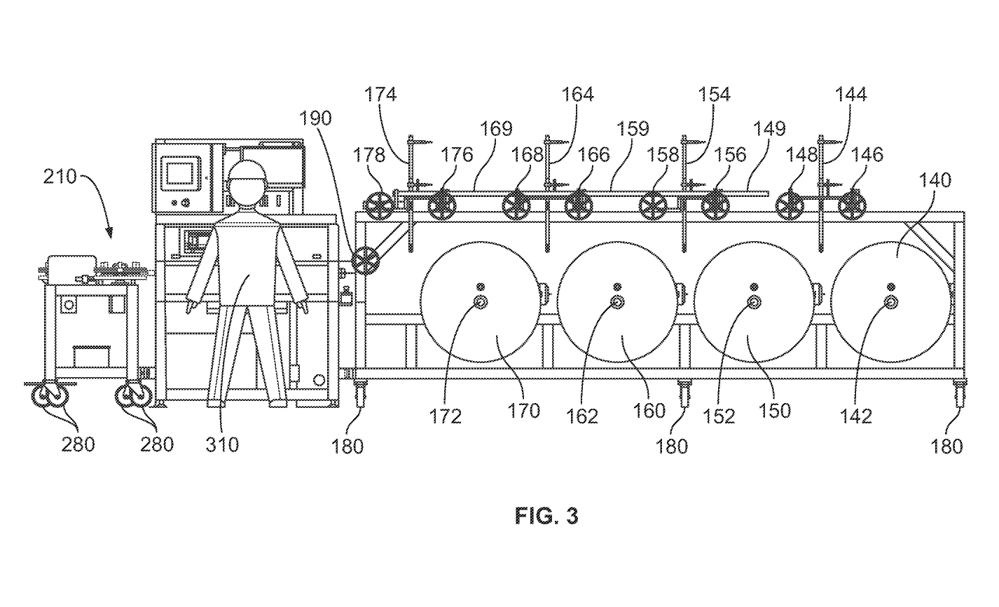

FIG. 3 shows a front view of the laser marking system 100 shown in FIG. 2. The first bobbin 140 may rotate about the first bobbin shaft 142 as fish tape material wound onto the first bobbin 140 is unspooled and fed or drawn through the print module. As noted above, the fish tape material wound on the first bobbin 140 will be unwound and fed or drawn over pulleys 146 and 148 and into first control conduit 149. The fish tape material from the first bobbin 140 passes through first control conduit 149, over additional pulleys located behind pulleys 178 and 190 in FIG. 3, and into the print module where indicia are laser marked onto the fish tape. A sensor 144 is shown positioned adjacent pulleys 146 and 148 and may sense the speed and/or distance the fish tape has traveled over the pulleys 146 and 148.

The second bobbin 150 may rotate about the second bobbin shaft 152 as fish tape material wound onto the second bobbin 150 is unspooled and fed or drawn through the print module. As noted above, the fish tape material wound on the second bobbin 150 will be unwound and fed or drawn over pulleys 156 and 158 and into second control conduit 159. The fish tape material from the second bobbin 150 passes through second control conduit 159, over additional pulleys located behind pulleys 178 and 190 in FIG. 3, and into the print module where indicia are laser marked onto the fish tape. A sensor 154 is shown positioned adjacent pulleys 156 and 158 and may sense the speed and/or distance the fish tape has traveled over the pulleys 156 and 158.

Similarly, the third bobbin 160 may rotate about the third bobbin shaft 162 as fish tape material wound onto the third bobbin 160 is unspooled and fed or drawn through the print module. As noted above, the fish tape material wound on the third bobbin 160 will be unwound and fed or drawn over pulleys 166 and 168 and into third control conduit 169. The fish tape material from the third bobbin 160 passes through third control conduit 169, over additional pulleys located behind pulleys 178 and 190 in FIG. 3, and into the print module where indicia are laser marked onto the fish tape. A sensor 164 is shown positioned adjacent pulleys 166 and 168 and may sense the speed and/or distance the fish tape has traveled over the pulleys 166 and 168.

Furthermore, the fourth bobbin 170 may rotate about the first bobbin shaft 172 as fish tape material wound onto the fourth bobbin 170 is unspooled and fed or drawn through the print module. As noted above, the fish tape material wound on the fourth bobbin 170 will be unwound and fed or drawn over pulleys 176 and 178 and ultimately exiting from the underside of pulley 190 where it is fed or drawn into the print module for laser marking of indicia onto the fish tape. A sensor 174 is shown positioned adjacent pulleys 176 and 178 and may sense the speed and/or distance the fish tape has traveled over the pulleys 176 and 178.

A control conduit could also be used for the fish tape material from the fourth bobbin 170. However, the proximity of the bobbin 170 to the print module is such that a control conduit is not necessary. Moreover the control conduit 149, 159, 169 is not required; however, it is preferred to properly guide the fish tape material along its path to the print module. In addition, the control conduit 149, 159, 169 may have various cross sections or sizes, such as round, square, or rectangular. Similarly, the pulleys associated with the fish tape material wound onto bobbins 140, 150, 160, and 170 are not required and other mechanisms, such as rollers or V-shaped grooves, could be used to guide the fish tape as it is unwound from the bobbins. In addition, where pulleys are used, it may be desirable to include V-shaped grooves on the pulleys so that fish tape material of varying diameter or cross section may be used with the pulleys. In addition, it may be desirable to provide the pulleys, such as pulleys 146 and 148, with the ability to pivot to accommodate the changing angle of the fish tape as it moves back and forth on the bobbin as the fish tape is unwound from the bobbin. Once the fish tape material from bobbins 140, 150, 160, and 170 has been laser marked with appropriate indicia it may be wound onto take up bobbins or mandrels positioned on take module 210.

FIG. 4 shows a rear view of the laser marking system shown in FIGS. 2 and 3. The first bobbin 140 is shown with a motor 147 that may serve to rotate the first bobbin 140 so that a desired length of fish tape material is unwound from the first bobbin 140 for laser marking the indicia. The motor is preferably a stepper motor that may start, stop, and restart as required to allow the laser marking of indicia onto the fish tape material at the appropriate predetermined locations on the fish tape material. The motor 147 in the preferred embodiment is a stepper motor and a gearbox capable of controlling a 300 pound bobbin.

The second bobbin 150 is shown with a separate motor 157 that may serve to rotate the second bobbin 150 so that a desired length of fish tape material is unwound from the second bobbin 150 for laser marking the indicia. The motor is preferably a stepper motor that may start, stop, and restart as required to allow the laser marking of indicia onto the fish tape material at the appropriate predetermined locations on the fish tape material. The motor 157 in the preferred embodiment is a stepper motor and a gearbox capable of controlling a 300 pound bobbin.

The third bobbin 160 is also shown with a separate motor 167 that may serve to rotate the third bobbin 160 so that a desired length of fish tape material is unwound from the third bobbin 160 for laser marking the indicia. The motor is preferably a stepper motor that may start, stop, and restart as required to allow the laser marking of indicia onto the fish tape material at the appropriate predetermined locations on the fish tape material. The motor 167 in the preferred embodiment is a stepper motor and a gearbox capable of controlling a 300 pound bobbin.

The fourth bobbin 170 also is shown with a separate motor 177 that may serve to rotate the fourth bobbin 170 so that a desired length of fish tape material is unwound from the fourth bobbin 170 for laser marking the indicia. The motor is preferably a stepper motor that may start, stop, and restart as required to allow the laser marking of indicia onto the fish tape material at the appropriate predetermined locations on the fish tape material. The motor 177 in the preferred embodiment is a stepper motor and a gearbox capable of controlling a 300 pound bobbin.

Because each of the bobbins 140, 150, 160, and 170 has a respective motor 147, 157, 167, and 177 controlling the rotation of the bobbins, the system is capable of independently laser marking indicia onto fish tape material on each of the four print tracks within the print module. In other words, each of the four bobbins and fish tape material wound thereon may be fed or drawn through the laser marking zone separately and independently laser marked with indicia without regard to what is happening to the fish tape material on the other bobbins.

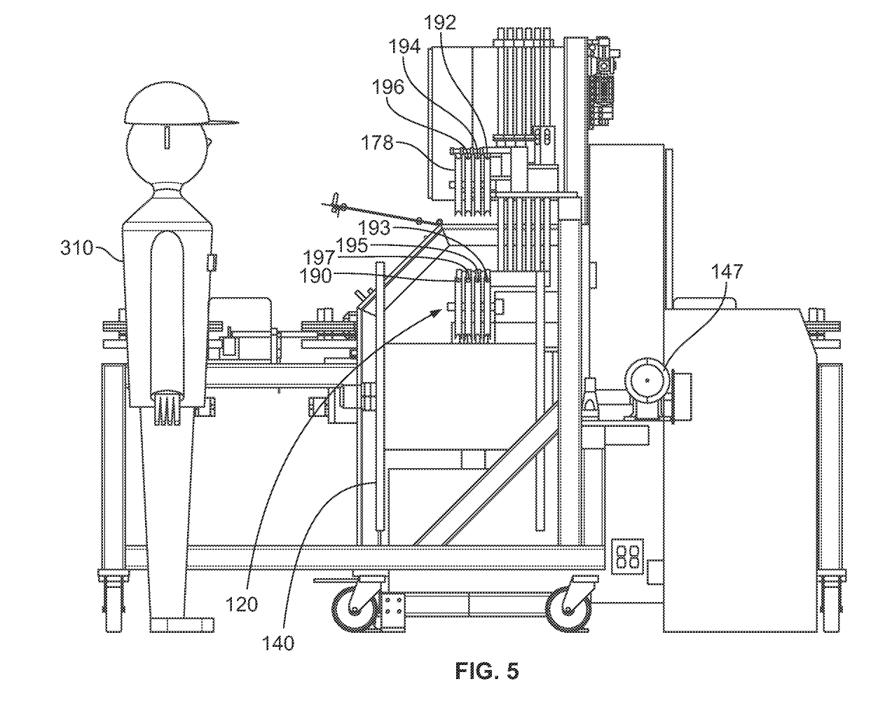

FIG. 5 is right side view of the laser marking system shown in FIGS. 2-4. First bobbin 140 is shown with motor 147 controlling the rotation of the first bobbin 140. Fish tape material wound onto the first bobbin 140 is ultimately fed over or drawn through pulley 192 and down to the underside of pulley 193 that is aligned with a first print track positioned within laser marking zone 120. Similarly, fish tape material wound onto the second bobbin 150 (shown in FIGS. 2-4) is ultimately fed over or drawn through pulley 194 and down to the underside of pulley 195 that is aligned with a second print track positioned within laser marking zone 120. In similar fashion, fish tape material wound onto the third bobbin 160 is ultimately fed over or drawn through pulley 196 and down to the underside of pulley 197 that is aligned with a third print track positioned within laser marking zone 120. Fish tape material wound onto the fourth bobbin 170 is ultimately fed over or drawn through pulley 178 and down to the underside of pulley 199 that is aligned with a fourth print track positioned within laser marking zone 120.

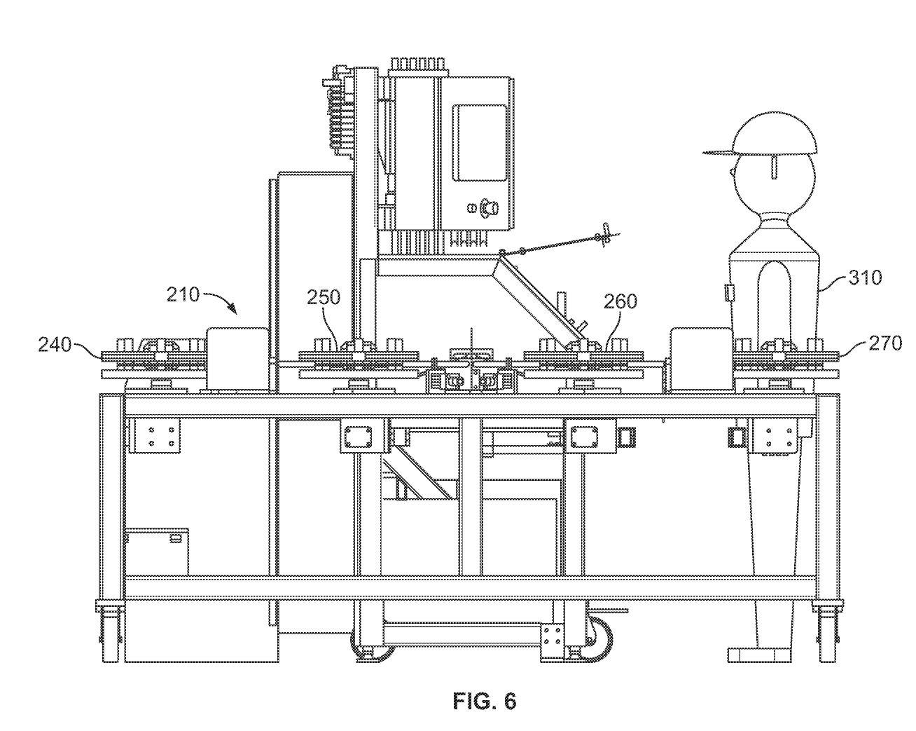

FIG. 6 is a left side view of the laser marking system shown in FIGS. 2-5. Operator 310 is shown behind the take up module 210. Take up module 210 includes first take up bobbin 240 upon which fish tape material from the first bobbin 140 (shown in FIGS. 2 and 3) has been laser marked on a first print track in the laser marking zone of the print module. In addition, take up module 210 includes second take up bobbin 250 upon which fish tape material from the second bobbin 150 (shown in FIGS. 2 and 3) has been laser marked on a second print track in the laser marking zone of the print module. Further, take up module 210 includes third take up bobbin 260 upon which fish tape material from the third bobbin 160 (shown in FIGS. 2 and 3) has been laser marked on a third print track in the laser marking zone of the print module. Also, take up module 210 includes fourth take up bobbin 270 upon which fish tape material from the fourth bobbin 170 (shown in FIGS. 2 and 3) has been laser marked on a fourth print track in the laser marking zone of the print module.

One or more of the take up bobbins 240, 250, 260, and 270 may include a top with a diameter suitable for coiling a particular length of fish tape, as well as a bottom with a diameter suitable for coiling a particular length of fish tape. In a preferred embodiment, one or more of the take up bobbins 240, 250, 260, and 270 may have a bottom with a diameter different from a diameter of the top so that the bottom is adapted to coil a length of fish tape that is different a length of fish tape may be coiled on the top. For example, the top of the take up bobbins may be dimensioned so that they are suitable for coiling a 100 foot length of fish tape whereas the bottom of the take up bobbins may be dimensioned so that they are suitable for coiling a 240 foot length of fish tape. Thus, for example, by removing take up bobbin 240 and flipping it over, the take up bobbin 240 may be suitable for coiling a 100 foot length of fish tape when the top is positioned upwardly and may be suitable for coiling a 240 foot length of fish tape when the bottom is positioned upwardly. In this manner, the take up bobbins may provide for more versatility and accommodate a larger number of anticipated lengths of fish tape. Thus, each length of fish tape may be cut to a proper length after the laser marking of indicia onto the fish tape, so that the take up bobbins each house a single coiled fish tape that may be easily transferred onto a fish tape housing suitable for individual sale.

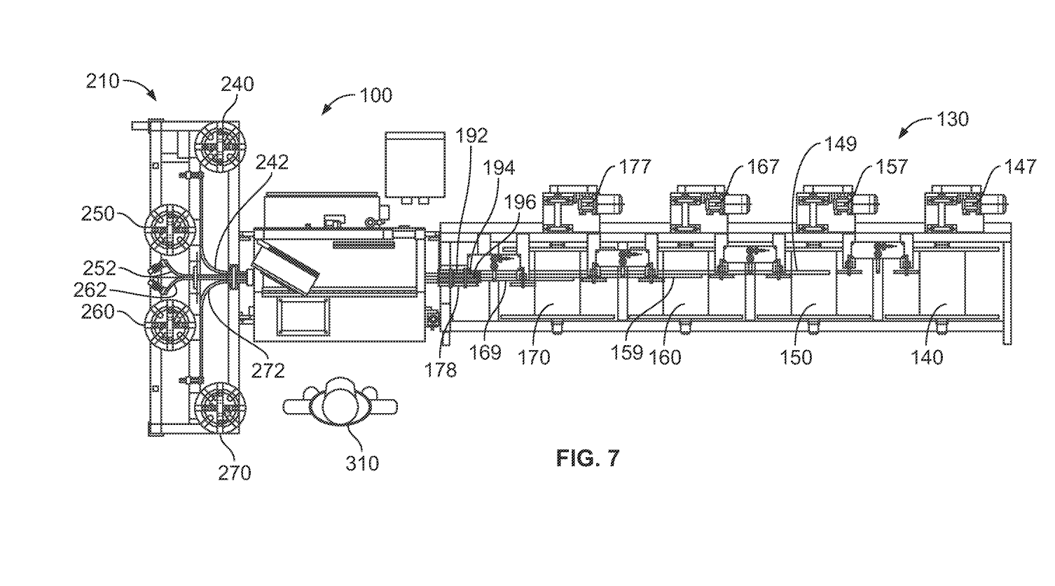

FIG. 7 is a top view of the laser marking system 100 shown in FIGS. 2-6. The first bobbin 140 is shown with a motor 147 that may serve to rotate the first bobbin 140 so that fish tape material is unwound from the first bobbin 140 where it passes into first control conduit 149 and then exits where it is fed or drawn onto pulley 192 which is aligned with a first print track positioned within the print module. The fish tape is eventually fed or drawn into the print module on the first print track for laser marking the indicia. After the fish tape material from the first bobbin 140 exits the print module, it passes through first control tube 242 and is coiled onto first take up bobbin 240.

Similarly, the second bobbin 150 is shown with a motor 157 that may serve to rotate the second bobbin 150 so that fish tape material is unwound from the second bobbin 150 where it passes into second control conduit 159 and then exits where it is fed or drawn onto pulley 194 which is aligned with a second print track positioned within the print module. The fish tape is eventually fed or drawn into the print module on the second print track for laser marking the indicia. After the fish tape material from the second bobbin 150 exits the print module, it passes through second control tube 252 and is coiled onto second take up bobbin 250.

In a similar fashion, the third bobbin 160 is shown with a motor 167 that may serve to rotate the third bobbin 160 so that fish tape material is unwound from the third bobbin 160 where it passes into third control conduit 169 and then exits where it is fed or drawn onto pulley 194 which is aligned with a third print track positioned within the print module. The fish tape is eventually fed or drawn into the print module on the third print track for laser marking the indicia. After the fish tape material from the third bobbin 160 exits the print module, it passes through third control tube 262 and is coiled onto third take up bobbin 260.

Further, the fourth bobbin 170 is shown with a motor 177 that may serve to rotate the fourth bobbin 170 so that fish tape material is unwound from the fourth bobbin 170 where it is drawn onto pulley 192 which is aligned with a fourth print track positioned within the print module. The fish tape is eventually fed or drawn into the print module on the fourth print track for laser marking the indicia. After the fish tape material from the fourth bobbin 170 exits the print module, it passes through fourth control tube 272 and is coiled onto fourth take up bobbin 270. It will be appreciated that each of the control tubes 242, 252, and 262, and 272 may require the fish tape material to bend 90 degrees after exiting the laser marking zone before being wound onto take up bobbins 240, 250, 260, and 270, which serves to help with the coiling onto the take up bobbins 240, 250, 260, and 270. Pneumatically operated cutters may be used to cut the fish tape material at the appropriate length after the fish tape exits the print module.

The print module 340 shown in FIG. 2 includes the laser system 106 and laser controller 108 that controls the operation and emission of electromagnetic radiation from a laser in the laser system 106. The laser controller 108 connects to a scan head (not shown) that directs the electromagnetic radiation generated by the laser beam in laser system 106. For example, the laser system 106 may include a 30-watt, Class IV laser. An example of a commercially available laser that may be used is a FOBA® Model DP30FGS Fiber laser, which is available from Virtek Vision International Inc.

The laser controller 108 may operate according to or include laser control software running, for example, on a Microsoft Windows® platform (e.g., XP or Vista®) to control the laser. The motion of mirrors (not shown) in the laser may be controlled by signals acquired from the distance sensing system 104 and/or speed sensing system 102, or the motors 147, 157, 167, or 177 so that the laser system 106 is operated to cause marks to be made on the fish tape material according to a selected program or one or more stored patterns or “recipes.” Generally, the fish tape movement and the length of fish tape material passing into the laser marking zone is controlled by encoders reading position and movement of the fish tape material, drive motors adjusting their respective speeds based on input from the sensors, control motors that control the tension/force on the fish tape material, and the windup bobbins which pull the fish tape through the laser marking zone using minimal force.

Additional details regarding the control of the distance and/or speed of the fish tape may be found in pending U.S. patent application Ser. No. 12/568,391 entitled “Method and System for Marking a Material Using a Laser Marking System” the entire contents of which are fully incorporated herein by reference as if fully set forth herein.

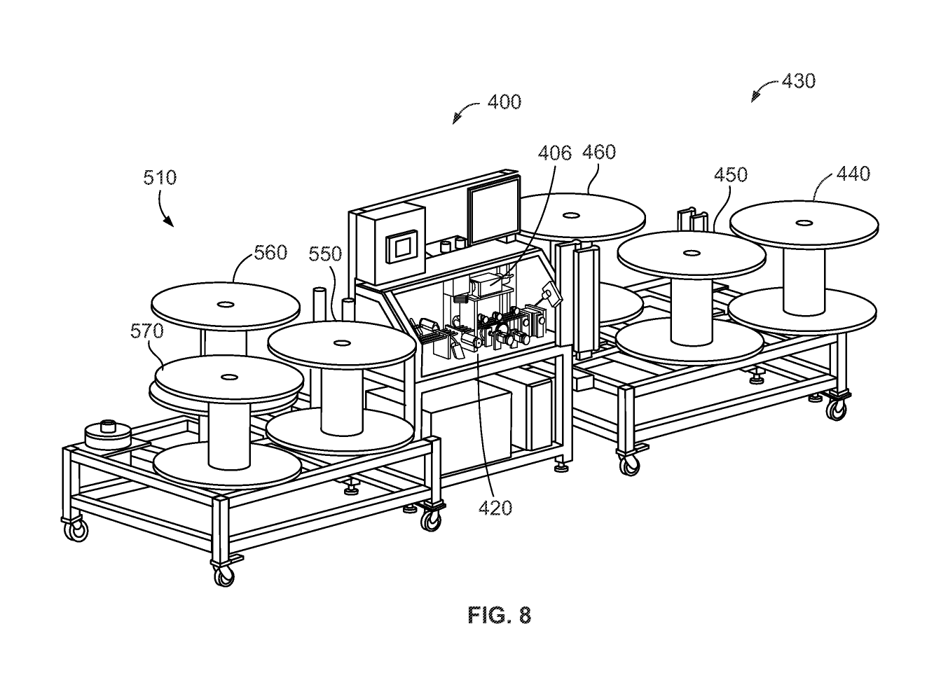

FIG. 8 discloses an alternate embodiment of a laser marking system 400. Laser marking system 400 includes a supply module 430 having supply bobbins 440, 450, and 460 which may be wound with fish tape material. The fish tape material is unwound from bobbins 440, 450, and 460 and pass into a laser marking zone 420 within a print module. After laser marked indicia is applied to the fish tape material it is directed to take up bobbins 550, 560, and 570 positioned on take up module 510.

In this embodiment of FIG. 8, the supply bobbins 440, 450, and 460 are positioned 90 degrees from the bobbins 140, 150, 160, and 170 shown in FIGS. 2-7. This is simply an alternate way of positioning the supply bobbins. In addition, in this embodiment, after the fish tape has been laser marked with indicia the fish tape material is wound directly onto the take up bobbins 550, 560, and 570 without cutting the fish tape material. In this manner, a long run of fish tape with desired indicia laser marked thereon may be provided on each of the take up bobbins where it may be stored until ready for later processing.

For example, take up bobbin 550 could be provided with a continuous run of fish tapes marked from 0 to 50 feet (or vice versa) that could be later unwound, cut to the proper lengths, and attached and wound onto individual fish tape housings suitable for individual sale. In the same manner, take up bobbin 560 could be provided with a continuous run of fish tapes marked from 0 to 100 feet (or vice versa) that could be later unwound, cut to the proper lengths, and attached and wound onto individual fish tape housings suitable for individual sale. Further, take up bobbin 570 could be provided with a continuous run of fish tapes marked from 0 to 240 feet (or vice versa) that could be later unwound, cut to the proper lengths, and attached and wound onto individual fish tape housings suitable for individual sale.

As noted above, the fish tape material is preferably comprised of a fiberglass core with a nylon jacket that has a round cross section with a 3/16 inch diameter. The nylon jacket may be extruded over the fiberglass core. In a preferred embodiment, the nylon jacket includes an additive that changes color when exposed to the laser beam to provide permanent marking of indicia on the fish tape. The additive may be an additive known as Lazerflair available from Merck which is a dry powder pigment that can be incorporated into the nylon used for the jacket in a known manner. The Lazerflair product is typically 0.3% to 0.5% in the final product and of the Lazerflair products, the Lazerflair 825 product is preferred. The additive may also be Micabs which is also available from Merck. Micabs consists of micron-sized particles which contain both a laser absorber and a color former. The particles turn black when exposed to a laser beam and provide a permanent contrast with the nylon. Micabs are available as granules and can be dosed via normal dosing equipment available to plastics converters. The Micabs product may be up to 2% of the final product and of the Micabs products, the Micabs A208 product is preferred. Other additives that change properties when exposed to a laser beam, such as those available from TRP Co., may also be used. Although nylon is preferred as the jacket material, polypropylene or PVC are examples of other materials that could be used for the jacket.

Although a fish tape material having a fiberglass core with a nylon jacket that has a round cross section that has a diameter of 3/16 inches is preferred, the fish tape could be comprised of other materials as well. For example, the fish tape material may comprise a nylon core with a fiberglass jacket. In addition, the fish tape material may comprise tempered spring steel, stainless steel, nylon, fiberglass, or a multi-stranded wire as examples. In addition, the fish tape could have round diameter smaller or greater than 3/16 inches, e.g., ⅛ inch diameter or ¼inch diameter. Similarly, instead of a round cross section, the fish tape could have a cross section with other geometries, e.g., oval rectangular, square, flat stock, etc.

The preferred fish tape includes a laser marked nylon jacket and a fiberglass core having a diameter of 0.080 inches. Using the preferred fish tape material and laser, the marking of the indicia onto the fish tape may done relatively quickly and accurately. For example, the estimated time for the material handling of one foot of fish tape material may be 1 second, which comprises 0.25 seconds for the start of movement, 0.5 seconds for the movement of the one foot of fish tape through the laser marking zone, and 0.25 seconds for the stopping of the fish tape material. The time for laser marking the indicia onto the fish tape is variable based on the number of digits that are laser marked. For example, the marking of a single digit representing one foot, e.g. (“1′”) and associated tick mark may take 0.2 seconds, the marking of two digits representing 12 feet, e.g., (“12′”) and associated tick mark may take 0.27 seconds, and the marking of three digits representing 123 feet, e.g., (“123′”) and associated tick mark may take 0.36 seconds.

With the above described laser marking system, indicia may be laser marked onto the fish tape material in either ascending or descending order, depending on the desired end product and depending on whether the fish tape will (a) be cut to length after exiting the print module, (b) wound onto take up bobbins and cut for later attachment and spooling onto a fish tape housing, or (c) remain uncut and wound onto take up bobbins.

In addition, the laser marking system may include up to four or more parallel print tracks that each have the capability of independently laser marking the fish tape material on the print track. Thus, the laser marking system may run any length of fish tape on any of the four print tracks at the same time. When all four print tracks are marking indicia on four separate fish tapes at the same time, greater efficiencies are achieved. For example, 50 foot lengths, 100 foot lengths, 125 foot lengths, and 240 foot lengths of fish tape could all be run and laser marked with indicia at the same time. Of course not all of the print tracks need to be utilized at the same time, and if desired only one or two print tracks could be operational. The laser indicia is preferably marked using a move, stop, print, move sequence which allows for greater flexibility and accuracy than on the fly laser marking. Using the move, stop, print, move sequence, tolerances can be as small as 0.006″/foot.

As noted above, with up to four independent print tracks, when one print track is taken out of operation for maintenance, changing a supply bobbin, e.g., the remaining print tracks may continue to laser mark the fish tape material passing through the laser marking zone of the print module. This maximizes operator time because the laser marking on the other three print tracks may continue even though one of the print tracks is taken off line. Four independent print tracks also provides for increased versatility as four different types of fish tapes may be marked at the same time.

It will be appreciated that in the disclosed embodiments there are four independent print tracks. However, fewer or more independent print tracks could also be used. For example, two or three independent print tracks could be operated by taking one of the supply bobbins off line. Alternately, five or more independent print tracks could also be used, but would require more supply bobbins, more take up bobbins, and likely more lasers. In a preferred embodiment four print tracks are used which can be operated under existing space and operational constraints.

Example embodiments of the present invention have been described above. Those skilled in the art will understand that changes and modifications may be made to the described embodiments without departing from the true scope and spirit of the present invention, which is defined by the claims.

I claim:

1. A laser marking system for marking indicia onto fish tape material comprising:
a laser marking module that includes a laser system for directing a laser beam towards a first print track and towards a second print track positioned within a laser marking zone;
a first source of a first fish tape material;
a first fish tape guide for guiding the first fish tape material onto the first print track;
a first controller for controlling the movement of the first fish tape over the first print track;
a second source of a second fish tape material;
a second fish tape guide for guiding the second fish tape material onto the second print track;
a second controller for controlling the movement of the second fish tape over the second print track;
wherein movement of the first fish tape material may be performed independently from the movement of the second fish tape material; and
wherein first laser indicia may be marked on the first fish tape material positioned on the first print track in the laser marking zone by the laser beam and second laser indicia may be marked on the second fish tape material positioned on the second print track in the laser marking zone by the laser beam.

2. The laser marking system of claim 1, wherein the first fish tape guide comprises one or more pulleys that guide the first fish tape material towards the first print track.

3. The laser marking system of claim 2, wherein the first fish tape guide further comprises a first control conduit through which the first fish tape material passes through.

4. The laser marking system of claim 3, further including a take up module having a first take up bobbin for winding up the first fish tape material after it passes through the laser marking zone and a second take up bobbin for winding up the second fish tape material after it passes through the laser marking zone.

5. The laser marking system of claim 4, further including a first control tube through which the first fish tape material passes through after it passes through the laser marking zone that directs the first fish tape material onto the first take up bobbin.

6. The laser marking system of claim 5, further including a second control tube through which the second fish tape material passes through after it passes through the laser marking zone that directs the second fish tape material onto the second take up bobbin.

7. The laser marking system of claim 1, wherein the first laser indicia is different than the second laser indicia.

8. The laser marking system of claim 4, where the length of the first fish tape material wound onto the first take up bobbin is different than the length of the second fish tape material wound onto the second take up bobbin.

9. The laser marking system of claim 1, where the first fish tape material is different than the second fish tape material.

10. The laser marking system of claim 3, further including a first motor that may be used to rotate a first supply bobbin to unwind the first source of fish tape material from the first supply bobbin and a second motor that may be used to rotate a second supply bobbin to unwind the second source of fish tape material from the second supply bobbin.

11. The laser marking system of claim 1, wherein the movement of the first fish tape material through the laser marking zone is stopped and first laser indicia may be laser marked onto the first fish tape material when the first fish tape material is stationary within the laser marking zone.

12. The laser marking system of claim 11, wherein the movement of the second fish tape material through the laser marking zone is stopped and second laser indicia may be laser marked onto the second fish tape material when the second first fish tape material is stationary within the laser marking zone.

13. The laser marking system of claim 1, wherein the first controller is separate from the second controller.

14. The laser marking system of claim 1, further including a third print track positioned within the laser marking zone;
a third source of a third fish tape material;
a third fish tape guide for guiding the third fish tape material onto the third print track;
a third controller for controlling the movement of the third fish tape over the third print track;
wherein movement of the third fish tape material may be performed independently from the movement of the first fish tape material and the second fish tape material; and
wherein third laser indicia may be marked on the third fish tape material positioned on the third print track in the laser marking zone by the laser beam.

15. The laser marking system of claim 14, wherein the third fish tape guide comprises one or more pulleys that guide the third fish tape material towards the third print track.

16. The laser marking system of claim 15, wherein the third fish tape guide further comprises a third control conduit through which the third fish tape material passes through.

17. The laser marking system of claim 14, further including a third take up bobbin on the take up module for winding up the third fish tape material after it passes through the laser marking zone.

18. The laser marking system of claim 17, further including a third control tube through which the third fish tape material passes through after it passes through the laser marking zone that directs the third fish tape material onto the third take up bobbin.

19. The laser marking system of claim 14, wherein the third laser indicia is different than the first laser indicia and the second laser indicia.

20. The laser marking system of claim 17, where the length of the third fish tape material wound onto the third take up bobbin is different than the length of the first fish tape material wound onto the first take up bobbin and the length of the second fish tape material wound onto the second take up bobbin.

21. The laser marking system of claim 14, where the third fish tape material is different than the first fish tape material and the second fish tape material.

22. The laser marking system of claim 14, further including a third motor that may be used to rotate a third supply bobbin to unwind the third fish tape material from the third supply bobbin.

23. The laser marking system of claim 14, wherein the movement of the third fish tape material through the laser marking zone is stopped and third laser indicia may be laser marked onto the third fish tape material when the third fish tape material is stationary within the laser marking zone.

24. The laser marking system of claim 14, further including a fourth print track positioned within the laser marking zone;
a fourth source of a fourth fish tape material;
a fourth fish tape guide for guiding the fourth fish tape material onto the fourth print track;
a fourth controller for controlling the movement of the fourth fish tape over the fourth print track;
wherein movement of the fourth fish tape material may be performed independently from the movement of the first fish tape material, the second fish tape material, and the third fish tape material; and
wherein fourth laser indicia may be marked on the fourth fish tape material positioned on the fourth print track in the laser marking zone by the laser beam.

25. The laser marking system of claim 24, wherein the fourth fish tape guide comprises one or more pulleys that guide the fourth fish tape material towards the fourth print track.

26. The laser marking system of claim 24, further including a fourth take up bobbin on the take up module for winding up the fourth fish tape material after it passes through the laser marking zone.

27. The laser marking system of claim 26, further including a fourth control tube through which the fourth fish tape material passes through after it passes through the laser marking zone that directs the fourth fish tape material onto the fourth take up bobbin.

28. The laser marking system of claim 24, wherein the fourth laser indicia is different than the first laser indicia, the second laser indicia, and the third laser indicia.

29. The laser marking system of claim 26, where the length of the fourth fish tape material wound onto the fourth take up bobbin is different than the length of the first fish tape material wound onto the first take up bobbin or the length of the second fish tape material wound onto the second take up bobbin.

30. The laser marking system of claim 24, where the fourth fish tape material is different than the first fish tape material, the second fish tape material, and the third fish tape material.

31. The laser marking system of claim 24, further including a fourth motor that may be used to rotate a fourth supply bobbin to unwind the fourth fish tape material from the fourth supply bobbin.

32. The laser marking system of claim 24, wherein the movement of the fourth fish tape material through the laser marking zone is stopped and fourth laser indicia may be laser marked onto the fourth fish tape material when the fourth fish tape material is stationary within the laser marking zone.

33. A method of laser marking one or more fish tapes with indicia comprising the steps of:
moving a first fish tape material from a first source of fish tape material through a first fish tape guide onto a first print track positioned in a laser marking zone of a laser marking module that includes a laser system;
directing a laser beam towards the first fish tape material positioned in the first print track to laser mark the first fish tape material with first laser indicia;
moving a second fish tape material from a second source of fish tape material through a second fish tape guide onto a second print track positioned in the laser marking zone of the laser marking module;
directing a laser beam towards the second fish tape material positioned in the second print track to laser mark the second fish tape material with second laser indicia;
wherein movement of the first fish tape material is performed independently from the movement of the second fish tape material.

34. The method of laser marking of claim 33, wherein the first fish tape guide comprises one or more pulleys that guide the first fish tape material towards the first print track.

35. The method of laser marking of claim 34, wherein the first fish tape guide further comprises a first control conduit through which the first fish tape material passes through.

36. The method of laser marking of claim 33, further including the step of winding the first fish tape material onto a first take up bobbin positioned on a take up module after the first fish tape material is marked with first laser indicia; and
the step of winding the second fish tape material onto a second take up bobbin positioned on the take up module after the second fish tape material is marked with second laser indicia.

37. The method of laser marking of claim 36, further including the step of passing the first fish tape material through a first control tube after it is marked with first laser indicia and before it is wound onto the first take up bobbin to direct the first fish tape material onto the first take up bobbin.

38. The method of laser marking of claim 37, further including the step of passing the second fish tape material through a second control tube after it is marked with second laser indicia and before it is wound onto the second take up bobbin to direct the second fish tape material onto the second take up bobbin.

39. The method of laser marking of claim 33, wherein the first laser indicia is different than the second laser indicia.

40. The method of laser marking of claim 36, where the length of the first fish tape material wound onto the first take up bobbin is different than length of the second fish tape material wound onto the second take up bobbin.

41. The method of laser marking of claim 33, where the first fish tape material is different than the second fish tape material.

42. The method of laser marking of claim 33, wherein the movement of the first fish tape material through the laser marking zone is stopped and the first laser indicia is laser marked onto the first fish tape material when the first fish tape material is stationary within the laser marking zone.

43. The method of laser marking of claim 42, wherein the movement of the second fish tape material through the laser marking zone is stopped and second laser indicia is laser marked onto the second fish tape material when the second first fish tape material is stationary within the laser marking zone.

44. The method of laser marking system of claim 33, further including the step of moving a third fish tape material from a third source of fish tape material through a third fish tape guide onto a third print track positioned in the laser marking zone of the laser marking module;
directing a laser beam towards the third fish tape material positioned in the third print track to laser mark the third fish tape material with third laser indicia;
wherein movement of the third fish tape material is performed independently from the movement of the first fish tape material and the second fish tape material.

45. The method of laser marking of claim 44, wherein the third fish tape guide comprises one or more pulleys that guide the third fish tape material towards the third print track.

46. The method of laser marking of claim 44, further including the step of winding the third fish tape material onto a third take up bobbin positioned on the take up module after the third fish tape material is marked with third laser indicia.

47. The method of laser marking of claim 46, further including the step of passing the third fish tape material through a third control tube after it is marked with third laser indicia and before it is wound onto the third take up bobbin to direct the third fish tape material onto the third take up bobbin.

48. The method of laser marking of claim 44, wherein the third laser indicia is different than the first laser indicia and the second laser indicia.

49. The method of laser marking system of claim 44, further including the step of moving a fourth fish tape material unwound from a fourth source of fish tape material through a fourth fish tape guide onto a fourth print track positioned in the laser marking zone of the laser marking module;
directing a laser beam towards the fourth fish tape material positioned in the fourth print track to laser mark the fourth fish tape material with fourth laser indicia;
wherein movement of the fourth fish tape material is performed independently from the movement of the first fish tape material, the second fish tape material, and the third fish tape material.

50. The method of laser marking of claim 49, wherein the fourth fish tape guide comprises one or more pulleys that guide the fourth fish tape material towards the fourth print track.

51. The method of laser marking of claim 49, further including the step of winding the fourth fish tape material onto a fourth take up bobbin positioned on the take up module after the fourth fish tape material is marked with fourth laser indicia.

52. The method of laser marking of claim 51, further including the step of passing the fourth fish tape material through a fourth control tube after it is marked with fourth laser indicia and before it is wound onto the fourth take up bobbin to direct the fourth fish tape material onto the fourth take up bobbin.

53. The method of laser marking of claim 49, wherein the fourth laser indicia is different than the first laser indicia, the second laser indicia, and the third laser indicia.
